(19) United States
(12) Patent Application Publication
(10) Pub. No.: US 2014/0165271 A1
(43) Pub. Date: Jun. 19, 2014

(54) ENCAPSULATING PROTECTIVE SUITS WITH ENHANCED WATER REPELLENCY

(71) Applicant: Ansell Limited, Richmond (AU)

(72) Inventor: Norman W. Keane, Selangor (MY)

(73) Assignee: Ansell Limited, Richmond (AU)

(21) Appl. No.: 14/109,067

(22) Filed: Dec. 17, 2013

Related U.S. Application Data
(60) Provisional application No. 61/738,648, filed on Dec. 18, 2012.

(51) Int. Cl. A62B 17/00

(52) U.S. Cl. CPC A62B 17/006
USPC 2/456; 2/455

(57) ABSTRACT

Provided among other things is a protective garment having one or more of: (a) an outer layer of a material that is self-extinguishing, and which is fluoro rubber, polyvinyl chloride, chlorosulfphonated polyethylene, chlorinated polyethylene, chloroprene rubber, or a mixture thereof, or (b) an inner layer of a barrier laminate, wherein an outer surface of the outer layer or an inner surface of the inner layer is modified with a hydrophobic chemical.

### CROSS-REFERENCE TO RELATED APPLICATION

This application claims benefit of U.S. Provisional Patent Application Ser. No. 61/738,648 filed Dec. 18, 2012, which is incorporated herein by reference.

### FIELD OF THE INVENTION

Embodiments of the present invention generally relate to protective garments, such as encapsulating protective garments, with water and/or contaminant repellant surfaces.

Hazmat suits typically have a non-absorptive outer layer and inner layers of a barrier laminate of elastomers, thermoplastic films and woven fabrics that is particularly resistant to permeation. As manufactured by Ansell Protective Solutions AB (Sweden), these are often multilayer structures with an impermeable outer layer that is typically non-absorptive, and an inner layer of a barrier laminate of thermoplastic films that is particularly resistant to permeation by chemical contaminants.

As described in “Methods of Decontamination after Chemical Incidents Summary Report”, Research Report #63, 1994, of the Central Fire Brigades Advisory Counsel Scottish Central Fire Brigades Advisory Counsel Jt. Committee on Fire Research, after a hazmat suit is used in an incident, the process of cleaning the suit can be laborious, and is often not as effective as might be hoped.

The materials of the outer layer of such suits is such that it is not apparent that repellency can be particularly enhanced with fluoropolymer treatments. The inner layer is not a target of the cleaning taught in Research Report #63. Yet for the circumstances where there has been a penetration of the suit, or the potential that there was a penetration of the suit, interior repellency can be useful for more fully cleaning the suit.

### SUMMARY OF THE INVENTION

Embodiments of the present invention generally relate to protective garments (e.g., hazmat suits) having an outer layer of a material that is self-extinguishing, and which is fluoro rubber, polyvinyl chloride, chlorosulfphonated polyethylene, chlorinated polyethylene, chloroprene rubber, or a mixture thereof, the exterior surface of the outer layer modified with a hydrophobic chemical, such as a fluoropolymer. In certain embodiments, the modification is done by contacting the surface with a fluoropolymer dispersion. In certain embodiments, the modification is done by contacting the surface with a fluoromonomer gas or aerosol while generating a plasma in the gas or aerosol. In certain embodiments, hydrophobic microparticles are contacted with the surface in conjunction with the hydrophobic chemical.

In certain embodiments, the outer layer is fluoro rubber, chlorosulfphonated polyethylene, chlorinated polyethylene, chloroprene rubber, or a mixture thereof. In certain embodiments, the outer layer is fluoro rubber, chloroprene rubber, or a mixture thereof.

Embodiments of the present invention relate to protective garments having an inner layer of a barrier laminate, the inner surface of the inner layer modified with a hydrophobic chemical, such as a fluoropolymer. In certain embodiments, the modification is done by contacting the surface with a fluoropolymer dispersion. In certain embodiments, the modification is done by contacting the surface with a fluoromonomer gas or aerosol while generating a plasma in the gas or aerosol. In certain embodiments, hydrophobic microparticles are contacted with the surface in conjunction with the hydrophobic chemical.

Embodiments of the present invention relate to protective garments (e.g. hazmat suits) that are stretchable diving suits having an outer layer of hydrogenated nitrile butadiene rubber (“HNBR”), the exterior surface of the outer layer modified with a hydrophobic chemical, such as a fluoropolymer. In certain embodiments, the modification is done by contacting the surface with a fluoropolymer dispersion. In certain embodiments, the modification is done by contacting the surface with a fluoromonomer gas or aerosol while generating a plasma in the gas or aerosol. In certain embodiments, hydrophobic microparticles are contacted with and attached to the surface in conjunction with the hydrophobic chemical. The contacting can be before, concurrent with, or after contacting with hydrophobic chemical. Attachment comprises association sufficient so that the hydrophobic particles contribute to water repellency of the so modified surface.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 shows an exemplary multi-layer structure for an protective garment.

While the invention is described herein by way of example using several embodiments and illustrative drawings, those skilled in the art will recognize that the invention is not limited to the embodiments of drawing or drawings described. It should be understood that the drawings and detailed description thereto are not intended to limit the invention to the particular form disclosed, but on the contrary, the invention is to cover all modification, equivalents and alternatives falling within the spirit and scope of the present invention as defined by the appended claims. The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include,” “including,” and “includes” mean including, but not limited to.

### DETAILED DESCRIPTION

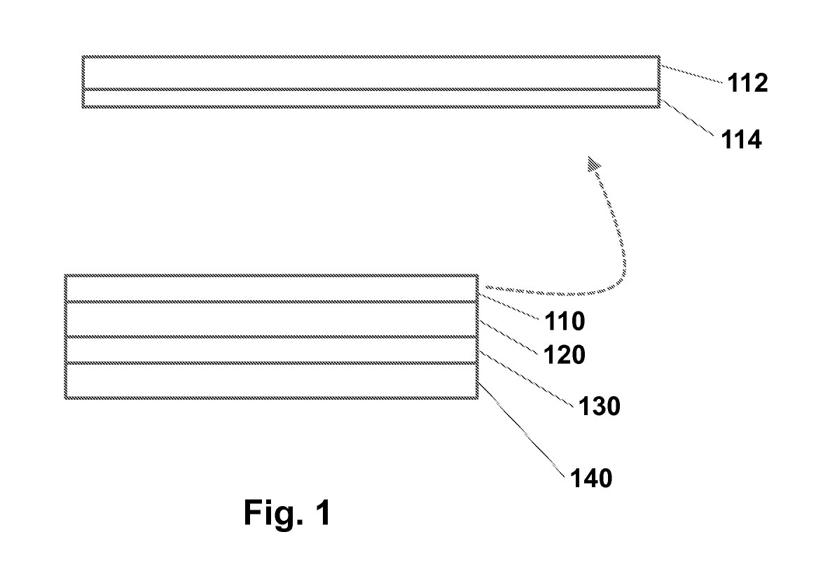

Protective garments (such as suits, gloves or the like) can for example have four or five layers, as illustrated in FIG. 1. Layer 110, the outer layer, can be two layers, with sublayers 112 and 114, as indicated by the blown-up layer indicated by the dotted arrow. Layer 110, or sublayer 112 (either of which can be termed the “outer barrier layer”), are for example composed of fluoro rubber, polyvinyl chloride, chlorosulfphonated polyethylene, chlorinated polyethylene, chloroprene rubber, or a mixture thereof. Sublayer 114 is a transition layer, such as a layer of butyl rubber. Sublayer 114 can be used for example where sublayer includes fluoro rubber.

It is believed to be particularly surprising to obtain a benefit by treating a fluoro rubber, chlorosulfphonated polyethylene, chlorinated polyethylene, chloroprene rubber, or a mixture thereof according to the invention. It is believed to be particularly surprising to obtain a benefit by treating a fluoro rubber, chloroprene rubber, or a mixture thereof according to the invention. It is believed to be particularly surprising to obtain a benefit by treating a fluoro rubber according to the invention.

In certain embodiments, the garment is an encapsulating protective suit. An encapsulating protective suit is a suit configured to cover most of torso, arms and legs of a user, having overlapping seam(s) where it opens to allow donning, and configured to provide overlapping seams to connect any foot, hand, head or face garments. The overlapping seams provide, in conjunction with the materials of the garments, resistance to penetration of chemicals.

By the expression “a (fiber) material which is self-extinguishing” is herein meant a (fiber) material which does not support burning of the (fiber) material or a (fiber) material that burns only slowly, i.e. the (fiber) material self-extinguishes when it is drawn out from a flame.

Second layer 120 is for example a fiber material, which is self-extinguishing. Temperature resistance and/or flame retardant ability can be features of the fiber material. A common mistake is to confuse these features with each other. Flame retardant ability is generally measured by the Limiting Oxygen Index, LOI. LOI, basically, is the amount of oxygen needed in the atmosphere to support combustion. Fibers with a LOI greater than 25 are said to be flame retardant, which means that there must be at least 25% oxygen present in order for them to burn. With a broad interpretation of the LOI, one could say that a LOI greater than 21 implies a flame retardant ability due to the fact that air contains 21% oxygen. The LOI of a fiber material can be influenced by e.g. adding a flame retardant finish to the fiber material. Another feature of importance for the flame retardant ability of a fiber material layer is the density or tightness of the weave of the fiber material. This is e.g. measured by the number of ends and picks per unit of length of the fiber material. Therefore, according to one specific embodiment of the present invention, the second layer is a fabric having at least 175 ends/10 cm and 175 picks/10 cm, respectively, and having a LOI (Limiting Oxygen Index) greater than 25. There is of course fiber materials having a LOI which is significantly higher than 25 and fiber material layers having significantly higher values than 175 ends/10 cm and 175 picks/10 cm, respectively, which also are possible, and sometimes preferred, to use as the material of the second layer of the present invention.

According to one specific embodiment of the present invention, the second layer 120 comprises at least one Meta-aramid having a LOI of 25-35, at least one Para-aramid having a LOI of 25-30, at least one poly-phenylene benzobisoxazole compound having a LOI of 65-75, at least one polybenzimidazole compound having a LOI of 35-45, at least one polyimide fiber material having a LOI of 35-45, or at least one carbon precursor fiber material having a LOI of 55-75, or a combination thereof.

Third layer 130 can comprise some of the same compounds which may be comprised in the first layer 110 of the present invention. The layer can be adhesive. Therefore, according to one specific embodiment of the present invention, the third layer 130 of the present invention is a material comprising at least one compound chosen from the group consisting of polyvinyl chloride, butyl rubber and chloroprene rubber. Third layer 130 can consist of other typical adhesive materials used for these types of applications.

Fourth layer 140 can be a barrier laminate, which is a multilayered film of thermoplastics. Such a barrier laminate is described for example in U.S. Pat. No. 4,772,348, the disclosure of which laminate is incorporated herein in its entirety.

A specific description of materials for an encapsulating protective suit can be found for example in U.S. Pat. No. 8,247,077.

Hydrophobic Chemicals for Use with or without Hydrophobic Microparticles

Liquid repellency treatments for textile have traditionally been via fluorine chemistry. There are many commercial liquid repellents for fabric now available in the market. Typically, a repellent composition contains an aqueous dispersion of perfluorinated copolymer. Other components such as filler, catalyst, crosslink agent, resin, and the like also can be added into the mixture to enhance the repellent effect and durability of the coating. These additional components can be used with the hydrophobic chemical component of the current invention.

Recently, a patent filed by Wang et al. (US Patent No: US 2011/0315047 A1) reported about treatment methods based on various combinations of fluorinated copolymers and a water based wax dispersion (Freepel® 1225). The fluorinated copolymers used in this invention include: perfluoroalkyl acrylic copolymer (Zonyl® 8300), anionic perfluoropolyether based polyurethane and polytetrafluoroethylene (Fluorolink® 5049), and perfluoropolyether based triethosilane (Fluorolink® S10). (All of these can be used as the hydrophobic chemical component of the current invention. The description in this '047 patent application of fluoro-polymer treatments is incorporated herein in its entirety.) The glove is either sprayed or dipped into the liquid treatment. This treatment is then dried for a short period in oven to make it durable.

Hydrophobic chemicals can include those of the commercial products Softgard M3 (soft chemicals, Italy), Oleophobol 7752 (Huntsman, Germany), Ruco-Gard AIR and Ruco-Dry DHY (Rudolf Chemie, Germany), Scotchgard (3M, Maplewood, Minn.), Zepel-B (Dupont, Wilmington, Del.), anionic perfluoropolyether based polyurethane and polytetrafluoroethylene (Fluorolink® 5049), and perfluoropolyether based triethosilane (Fluorolink® S10, available from Ausimont, Thorofare, N.J.), perfluoroalkyl acrylic co-polymer (such as Zonyl® 8300 available from Ciba Specialty, High Point, N.C.; and Scotchban™ FC-845 available from 3M, St. Paul, Minn.), perfluoroalkyl urethane (such as L-8977 available from 3M, St. Paul, Minn.), perfluoropolyether-modified polyurethane dispersion (such as Fluorolink™ P56 available from Ausimont, Thorofare, N.J.), fluorinated silicone polyester (such as Lambent™ WAX available from Lambent Technologies, Fernandina Beach, Fla.), polychlorotrifluoroethylene (such as Aclon™ PCTFE available from Honeywell, Morristown, N.J.), polyvinylidene fluoride dispersion (such as Unidyne™ TG available from Daikin America, New York, N.Y.), tetrafluoroethylene-hexafluoropropylene co-polymer (such as Dyneon™ FEP available from 3M, Parsippany, N.J.), polyperfluoroethoxymethoxydifluoroethyl PEG phosphate (such as Fomblin™ HC/2-1000 available from Solvay Solexis, Houston, Tex.), Oleophobol® CP-SLA (an aqueous dispersion of perfluorinated acrylic copolymer), like hydrophobic chemicals, and combinations thereof.

A variety of fluorochemical oil and water repellent compounds suitable for use in the present invention are known and are commercially available. One particular group of fluorochemical oil repellents are the polymers obtained by polymerizing an ethylenically unsaturated fluorochemical compound. The ethylenic unsaturation may be either in the alcohol or the acid portion of the ester molecule. Typically, the unsaturated radical in the alcohol portion of the ester may be the allyl radical or the vinyl radical. Typical unsaturated acids used to prepare the ester include acrylic acid, methacrylic acid and crotonic acid. In general, the perfluoro portion of the molecule should be in the saturated portion of the molecule. The unsaturated portion of the molecule is preferably not fluorinated in each instance. The acid and alcohols radicals may suitably contain from 2 to 6 carbon atoms excluding the carbonyl carbon of the acid. Examples of such monomers include vinyl perfluorobutyrate and perfluorobutyl acrylate. These monomers may be polymerized as homopolymers or as copolymers by normal emulsion polymerization techniques using free radical catalysts.

Some of these repellents are disclosed in an article by E. J. Grajeck and W. H. Petersen appearing in The Textile Research Journal, April, 1962, pp. 320-331, entitled “Oil and Water Fluorochemical Finishes for Cotton”.

Examples of suitable fluorochemical repellents are those known and sold under the trademarks “Scotchgard FC 208”, “Scotchgard FC 210”, “Scotchgard FC 232”, and Scotchgard FC 319”, manufactured by the 3M Company, “Zepel B” manufactured by E. I. DuPont de Nemours and Co. and “Tinotop T-10” manufactured by Ciba-Geigy Ltd.

Of these materials “Scotchgard FC 208” is an aqueous nonionic emulsion containing approximately 28% by weight of a modified fluorinated acrylic polymer: a substance believed to be of the following approximate general formula:

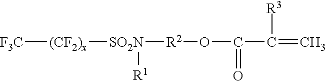

in which X is a value between 3 and 13 inclusive, R₁ is lower alkyl, such as methyl, ethyl, propyl, and the like, having 1-6 atoms R₂ is alkylene containing 1-12 carbon atoms and R₃ is H, methyl or ethyl. The product “Zepel” is also available in emulsion form and while it is chemically different from the “Scotchgard” products, it is a fluorochemical oil repellent containing fluorocarbon tails composed of CF₂ groups which may end in a terminal CF₃ group.

“Scotchgard FC-319” is a solution of a compound similar to “FC-208” in an organic solvent. “Scotchgard FC-232” is a dispersion of a fluorochemical resin in a mixture of water and methyl isobutyl ketone. “Zepel B” is an aqueous cationic dispersion of a fluorochemical resin and is a product of E. I. Dupont de Nemours and Company. These products are believed to fall within the classes of compounds disclosed in the following patent specifications (compound descriptions incorporated by reference in their entirety):

TABLE
UK Pat. No. 971,732, E. I. Dupont de Nemours & Co.
Canadian Pat. No. 942,900, E. K. Kleiner (Ciba-Geigy Co.)
Canadian Pat. No. 697,656, R. W. Fasick et al (Dupont)
French Pat. No. 1,568,181, H. Stockman
(National Starch & Chemical Co.)
U.S. Pat. No. 2,803,615, A. H. Ahlbrecht et al (3M Co.)
U.S. Pat. No. 2,826,564, F. A. Bovey et al (3M Co.)
U.S. Pat. No. 2,642,416, A. H. Ahlbrecht et al (3M Co.)
U.S. Pat. No. 2,839,513, A. H. Ahlbrecht et al (3M Co.)
U.S. Pat. No. 2,841,573, A. H. Ahlbrecht et al (3M Co.)
U.S. Pat. No. 3,484,281, R. A. Guenther et al (3M Co.)
U.S. Pat. No. 3,462,296, S. Raynolds et al (Dupont)
U.S. Pat. No. 3,636,085, E. K. Kleiner (Ciba-Geigy)
U.S. Pat. No. 3,594,353, E. Domba (Nalco Chemical Co.)
French Pat. No. 1,562,070, P. Sherman (3M Co.)
German Pat. No. 1,419,505, E. Langerak (Dupont)
U.S. Pat. No. 3,256,230, R. E. Johnson et al (Dupont)

Fluorolink® 5049 is a composition containing an anionic perfluoropolyether (PFPE) based polyurethane dispersion in water, polytetrafluoroethylene (PTFE) dispersion, isopropyl alcohol and methyl ethyl ketone, and is available from Solvay Solexis, Thorofare, N.J. Fluorolink® S10 is a composition containing a perfluoropolyether (PFPE)-based triethoxysilane dispersion in water, and is available from Solvay Solexis.

Wax dispersions can be used as the hydrophobic chemical, or as a supplement to a primary hydrophobic chemical (e.g., Freepel® 1225). Examples of water-based wax dispersions that can be used include, but are not limited to, synthetic wax (such as Freepel 11225 available from Noveon, Inc., Cleveland, Ohio); polyethylene wax (such as Michem™ ME available from Michelman, Cincinnati, Ohio; Luwax™ AF available from BASF, Parsippany, N.J.; Aquatec™ available from Eastman Chemical, Kingsport, Term.; and Jonwax™ available from S.C. Johnson Wax, Racine, Wis.); oxidized polyethylene wax (such as PoligenT WEI available from BASF, Parsippany, N.J.); ethylene acrylic acid copolymer EAA wax (such as Poligen™ WE available from BASF Parsippany, N.J.); ethylene vinylacetate copolymer wax (such as Aquacer™ available from BYK, Wallingford, Conn.); modified polypropylene wax (such as Aquaslip™ available from Lubrizol, Wickliffe, Ohio); silicone wax (such as DC 2503, DC2-1727, DC C-2-0563, DC 75SF and DC 580 available from Dow Corning, Midland, Mich.; Masilwax™ available from Noveon, Cleveland, Ohio; Silcare™ 41M available from Clariant, Charlotte, N.C.); fluoroethylene wax (such as Hydrocer™ available from Shamrock, Newark, N.J.); Carnauba wax (such as Slip-Ayd™ SL available from Daniel Products, Jersey City, N.J.); Fischer-Tropsch wax (such as Vestowax™ available from Degussa, Ridgefield, N.J.); and ester wax (such as Luwax™ E available from BASF, Parsippany, N.J.; and Lipowax™ available from Lipo, Paterson, N.J.), like waxes, and combinations thereof.

Optionally, cross-linker, catalyst for cross-linking resin or resin also can be used to further enhance the repellency and durability.

### Hydrophobic Microparticles

The hydrophobic microparticles can be those described in US 2010/0112204, US 2010/0159195 or U.S. Pat. No. 7,056,845, for example. The description of microparticles in these documents is incorporated by reference herein in their entirety. They can be silica particles. The microparticles include nanoparticles, so long as the ability to induce a lotus effect with water is retained. For example, the size range can be 0.01 to 10 micrometer.

The microparticles of US 2010/0112204 are reacted with linking reagents, followed by reaction with hydrophobic groups that attach to the resultant linking groups. Hydrophobic entities include C3-C24 hydrocarbon or C2-C12 perfluorinated carbon backbones.

A useful combination of hydrophobic microparticles and hydrophobic chemical is HeiQ Barrier® RCF (for example at 10-100 g/L), and HeiQ Barrier® HM (for example at 20-110 g/L).

The protective garment can be dipped into a formulation (for example an aqueous formulation) of the hydrophobic microparticles and/or the hydrophobic chemical. If separate formulations are used, the hydrophobic chemical formulation can usefully be dipped or otherwise applied second. Since the formulations are suspensions, stirring during dipping can be helpful.

### Plasma-Mediated Repellent Coatings

Plasma-mediated repellent coating processes can plasma enhanced vapor deposition processing. The result is believed to be a thin polymer layer on the surface. The process can be conducted at low pressure, with monomer precursor introduced as a vapor or aerosol and ionized. The coating layer is believed to be covalent and durable. The durability of improved repellency can be used to establish that a plasma-mediated coating has been applied, as opposed to a contacting with a hydrophobic chemical.

A plasma-mediated coating can be used in conjunction with hydrophobic microparticles, and it is believed that a plasma-mediated coating can improve the durability of the microparticles.

Conditions for plasma-mediated coating can include those described in U.S. Pat. Application 2009/0170391 (the teachings on plasma-mediated coating incorporated herein in their entirety), such as:

“Suitable plasmas for use in the method described herein include non-equilibrium plasmas such as those generated by radiofrequencies (Rf), microwaves or direct current (DC). They may operate at atmospheric or sub-atmospheric pressures as are known in the art. In particular however, they are generated by radiofrequencies (Rf).

“[0040] Various forms of equipment may be used to generate gaseous plasmas. Generally these comprise containers or plasma chambers in which plasmas may be generated. Particular examples of such equipment are described for instance in WO2005/089961 and WO02/28548, the contents of which are incorporated herein by reference, but many other conventional plasma generating apparatus are available.

“[0041] In general, the item to be treated is placed within a plasma chamber together with the material to be deposited in gaseous state, a glow discharge is ignited within the chamber and a suitable voltage is applied, which may be pulsed.

“[0042] The gas used within the plasma may comprise a vapour of the monomeric compound alone, but it may be combined with a carrier gas, in particular, an inert gas such as helium or argon. In particular helium is a preferred carrier gas as this can minimises fragmentation of the monomer.

“[0043] When used as a mixture, the relative amounts of the monomer vapour to carrier gas is suitably determined in accordance with procedures which are conventional in the art. The amount of monomer added will depend to some extent on the nature of the particular monomer being used, the nature of the laboratory disposable being treated, the size of the plasma chamber etc. Generally, in the case of conventional chambers, monomer is delivered in an amount of from 50-250 mg/min, for example at a rate of from 100-150 mg/min. Carrier gas such as helium is suitably administered at a constant rate for example at a rate of from 5-90, for example from 15-30 sccm. In some instances, the ratio of monomer to carrier gas will be in the range of from 100:1 to 1:100, for instance in the range of from 10:1 to 1:100, and in particular about 1:1 to 1:10. The precise ratio selected will be so as to ensure that the flow rate required by the process is achieved.

“[0044] Alternatively, the monomer may be delivered into the chamber by way of an aerosol device such as a nebuliser or the like, as described for example in WO2003/097245 and WO03/101621, the content of which is incorporated herein by reference.

In some cases, a preliminary continuous power plasma may be struck for example for from 2-10 minutes for instance for about 4 minutes, within the chamber. This may act as a surface pre-treatment step, ensuring that the monomer attaches itself readily to the surface, so that as polymerisation occurs, the coating “grows” on the surface. The pretreatment step may be conducted before monomer is introduced into the chamber, in the presence of only the inert gas.

“[0046] The plasma is then suitably switched to a pulsed plasma to allow polymerisation to proceed, at least when the monomer is present.

“[0047] In all cases, a glow discharge is suitably ignited by applying a high frequency voltage, for example at 13.56 MHz. This is suitably applied using electrodes, which may be internal or external to the chamber, but in the case of the larger chambers are internal.

Suitably the gas, vapour or gas mixture is supplied at a rate of at least 1 standard cubic centimeter per minute (sccm) and preferably in the range of from 1 to 100 sccm.

“[0049] In the case of the monomer vapour, this is suitably supplied at a rate of from 80-300 mg/minute, for example at about 120 mg per minute depending upon the nature of the monomer, whilst the pulsed voltage is applied.

“[0050] Gases or vapours may be drawn or pumped into the plasma region. In particular, where a plasma chamber is used, gases or vapours may be drawn into the chamber as a result of a reduction in the pressure within the chamber, caused by use of an evacuating pump, or they may be pumped or injected into the chamber as is common in liquid handling.

Polymerisation is suitably effected using vapours of compounds of formula (I), which are maintained at pressures of from 0.1 to 200 mtorr, suitably at about 80-100 mtorr.

“[0052] The applied fields are suitably of power of from 40 to 500 W, suitably at about 100 W peak power, applied as a pulsed field.

“[0053] The pulses are applied in a sequence which yields very low average powers, for example in a sequence in which the ratio of the time on:time off is in the range of from 1:500 to 1:1500. Particular examples of such sequence are sequences where power is on for 20-50 μs, for example about 30 μs, and off for from 1000 μs to 30000 μs, in particular about 20000 μs. Typical average powers obtained in this way are 0.01 W.”

The monomers described in U.S. App. Nos. 2009/0170391, 2010/0203347, 2010//0293812 or 2011/0078848 can be used (the teachings therein on plasma-mediated coating and monomers incorporated herein in their entirety).

One or a few protective garments (such as encapsulating protective suits) can be placed in a plasma chamber, positioned so that the plasma can reach the intended surfaces. Since the garment is impermeable, the seams can be closed (for example utilizing a place holder for the hands and feet) to expose the surface intended to be treated. The garments can be filled with gas (e.g., inert gas) to maximally expose their surfaces, or a brace can be placed in the garment adapted to present a smaller sized object while limiting the folding of the suit such that access of the plasma to the suit surfaces is not obstructed.

Alternatively, the garment material can be treated prior to be sewn into the suit.

For treatments of the interior surface, the garment can be inverted. The exterior surface can be protected from the plasma if desired. Or, the exterior, having been treated, or being intended to be treated, can be contacted with such plasma as leaks at the joints.

### Diving Garments

In one example embodiment the rubber material comprises 40-70% HNBR. HNBR contents of up to or less than 45, 50, 55, 60, 65% (w/w) are also useful in a diving garment according to at least one embodiment of the present invention.

In another example embodiment the rubber material comprises 40-70% (w/w) HNBR and 5-60% (w/w) of at least one filler.

In another example embodiment the rubber material according to the present invention comprises 5-30% (w/w) of at least one plasticizier.

In a further example embodiment the rubber material according to the present invention comprises 2-10% (w/w) of at least one curing agent.

Conventional fillers, plasticizers and curing agents can be used in example embodiments the present invention. An example of a filler in the rubber material of the diving suit of an example embodiment of the present invention is carbon black.

Information on HNBR, and its use in diving garments, can be found in U.S. Pat. No. 7,921,467, which information is incorporated herein in its entirety.

All ranges recited herein include ranges therebetween, and can be inclusive or exclusive of the endpoints. Optional included ranges are from integer values therebetween (or inclusive of one original endpoint), at the order of magnitude recited or the next smaller order of magnitude. For example, if the lower range value is 0.2, optional included endpoints can be 0.3, 0.4, . . . 1.1, 1.2, and the like, as well as 1, 2, 3 and the like; if the higher range is 8, optional included endpoints can be 7, 6, and the like, as well as 7.9, 7.8, and the like. One-sided boundaries, such as 3 or more, similarly include consistent boundaries (or ranges) starting at integer values at the recited order of magnitude or one lower. For example, 3 or more includes 4 or more, or 3.1 or more.

The foregoing description of embodiments of the invention comprises a number of elements, devices, machines, components and/or assemblies that perform various functions as described. These elements, devices, machines, components and/or assemblies are exemplary implementations of means for performing their respectively described functions.

Although only a few exemplary embodiments of the present invention have been described in detail above, those skilled in the art will readily appreciate that many modifications are possible in the exemplary embodiments without materially departing from the novel teachings and advantages of this invention.

1. A protective garment having one or more of:
an outer layer of a material that is self-extinguishing, and which is fluoro rubber, polyvinyl chloride, chlorosulfphonated polyethylene, chlorinated polyethylene, chloroprene rubber, or a mixture thereof, or
an inner layer of a barrier laminate,
wherein an outer surface of the outer layer or an inner surface of the inner layer is modified with a hydrophobic chemical.

2. The protective garment of claim 1, wherein the modification is the result of contacting the surface with a fluoropolymer dispersion.

3. The protective garment of claim 1, wherein the modification is the result of contacting the surface with a fluoromonomer gas or aerosol while generating a plasma in the gas or aerosol.

4. The protective garment of claim 1, wherein the modified surface includes hydrophobic particles.

5. The protective garment of claim 1, wherein the outer layer is modified with the hydrophobic chemical.

6. The protective garment of claim 5, wherein the protective garment is an encapsulating suit.

7. The protective garment of claim 5, wherein the outer layer is of a material which is fluoro rubber, chlorosulfphonated polyethylene, chlorinated polyethylene, chloroprene rubber, or a mixture thereof.

8. The protective garment of claim 5, wherein the outer layer is of a material which is fluoro rubber, chloroprene rubber, or a mixture thereof.

9. The protective garment of claim 5, wherein the outer layer is of a material which is fluoro rubber.

10. The protective garment of claim 1, wherein the inner layer is modified with the hydrophobic chemical.

11. The protective garment of claim 1, wherein the protective garment is an encapsulating suit.

12. A method of modifying a protective garment having one or more of:
an outer layer of a material that is self-extinguishing, and which is fluoro rubber, polyvinyl chloride, chlorosulfphonated polyethylene, chlorinated polyethylene, chloroprene rubber, or a mixture thereof, or
an inner layer of a barrier laminate,
the method comprising modifying an outer surface of the outer layer or an inner surface of the inner layer with a hydrophobic chemical.

13. The method of claim 12, wherein the modification is the result of contacting the surface with the fluoropolymer dispersion.

14. The method of claim 12, wherein the modification is the result of contacting the surface with a fluoromonomer gas or aerosol while generating a plasma in the gas or aerosol.

15. The method of claim 12, wherein hydrophobic particles are contacted with and attached to the surface.

16. The method of claim 12, wherein the outer layer is modified with the hydrophobic chemical.

17. The method of claim 16, wherein the protective garment is an encapsulating suit.

18. The method of claim 12, wherein the inner layer is modified with the hydrophobic chemical.

19. The method of claim 18, wherein the protective garment is an encapsulating suit.
